(19) United States
(12) Patent Application Publication
(10) Pub. No.: US 2012/0076889 A1
(43) Pub. Date: Mar. 29, 2012

(54) FLOWING DIRECTION REGULATOR AND THE MOULD WITH THE SAME

(75) Inventors: Jian-ming Li, Tu Cheng (TW); Xiao-ping Wu, Tu Cheng (TW); Shih-hsiung Ho, Tu Cheng (TW)

(73) Assignee: Cheng Uei Precision Industry Co., Ltd., Tu Cheng City (TW)

(21) Appl. No.: 12/894,131

(22) Filed: Sep. 29, 2010

(51) Int. Cl. B29C 45/30

(52) U.S. Cl. 425/542

(57) ABSTRACT

A flowing direction regulator and a mould with the same are provided. The flowing direction regulator is applied to a glue-dispensing runner of a plastic product for adjusting the flowing direction of the melt material in the runner. The flowing direction regulator includes a retaining portion and an extending portion extending outward from the retaining portion and entering into the runner. The flowing direction regulator can modify the width of the runner, so that effectively adjusting the melt plastic flow, resolving the problem of the different pressure needed by the different location of the plastic product, and effectively reducing the gas lines of the plastic-feeding location. The flowing direction regulator has a simple structure and a low cost, and can be conveniently operated. Moreover, the present mould can avoid to be taken apart and again fixed, thereby reducing the adjusting time, improving the working efficiency, and reducing the cost.

### BACKGROUND OF THE INVENTION

1. Field of the Invention

The present invention relates to an injection mould, and more particularly to a flowing direction regulator and the mould with the same.

2. Description of the Prior Art

In the prior technology, a hot runner system has been applied in an injection mould. In comparison with a mould having a cool runner system, the mould having the hot runner system has many advantages of saving material, enhancing the rate of production, improving the product quality and simplifying the subsequent machining process of the product.

Generally, the hot runner system can be used to dispense glue to the large plastic product. The main process is mounting the plastic product on the mould, and channeling the melt plastic to a plastic-feeding point of the plastic product by the aid of several runners. The operator employs a needle valved hot tip to inject the melt plastic into the runner thereby feeding the plastic into the plastic product. The needle valved hot tip also can control the flow of the melt plastic, the machining time and so on. The following is the working principle of the needle valved hot tip. A cylinder drives a center valve needle of the needle valved hot tip to move up and down. The needle valved hot tip is connected to an injection control system of injection molding machine. When the injection molding being started, the injection control system controls the center valve needle to go back for opening an injection port and making the melt plastic pass through. When completion of the injection molding, the center valve needle moves ahead to close the mould cavity for cut off the injection port. However, the structure of the needle valved hot tip is so complex that the operation thereof is inconvenient and the cost thereof is high.

Moreover, replacing the mould with different runner can change the flow of the melt plastic, the machining time of the plastic product and so on. But this method needs to continuously fix the mould, take apart the mould, and replace the different component. Therefore, this prior method spends a long time, reduces the working efficiency and has a high cost.

### BRIEF SUMMARY OF THE INVENTION

An object of the present invention is to provide a flowing direction regulator and the mould with the same, both of which have a simple structure and a low cost.

To achieve the above object, in accordance with the present invention, a flowing direction regulator is provided. The flowing direction regulator is applied to a glue-dispensing runner of a plastic product for adjusting the flowing direction of the melt material in the runner. The flowing direction regulator includes a retaining portion and an extending portion, which is extending outward from the retaining portion and enters into the runner.

To achieve the above object, in accordance with the present invention, a mould with a flowing direction regulator is also provided, comprising: a base board, a first runner, a second runner and a flowing direction regulator. The first and second runners are disposed on the base board. The second runner is communicated with the first runner, and passes through the base board. The flowing direction regulator is removable mounted on the base board and extends into the first runner.

Based on the above description, the extending portion of the flowing direction regulator of the present invention extends into the runner to modify the width of the runner, so that effectively adjusting the melt plastic flow of entering into the plastic product, resolving the problem of the different pressure needed by the different location of the plastic product, and effectively reducing the gas lines of the plastic-feeding location. The flowing direction regulator of the present invention has a simple structure and a low cost, and can be conveniently operated. Moreover, the mould of the present invention employs the flowing direction regulator, which is removable mounted on the base board and can be replaced by a new regulator to adjust the melt plastic-feeding flow according to the different plastic product, thereby avoiding to be taken apart and again fixed, reducing the adjusting time, improving the working efficiency, and reducing the cost.

### BRIEF DESCRIPTION OF THE DRAWINGS

FIG. 1 is a structure schematic view of a flowing direction regulator according to one embodiment of the present invention;

FIG. 2 is a structure schematic view of a mould with the flowing direction regulator according to one embodiment of the present invention; and

FIG. 3 is a structure schematic view of a plastic product, to which the mould with the flowing direction regulator is applied.

### DETAILED DESCRIPTION OF THE PREFERRED EMBODIMENTS

The following embodiment with reference to the accompanying drawings now has been given for detail describing the technology, the feature, the object and the effect of the present invention.

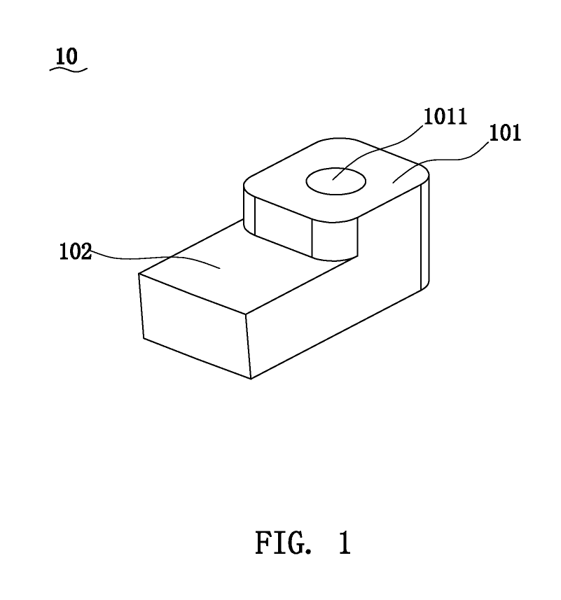

Please refer to FIG. 1, a flowing direction regulator 10 is mounted in a glue-dispensing runner of a plastic product for adjusting the flowing direction of the melt material in the runner. The flowing direction regulator 10 includes a retaining portion 101 and an extending portion 102 extending outward from the retaining portion 101 and entering into the runner.

Specifically, the retaining portion 101 and the extending portion 102 are configured as a step-like profile, and the retaining portion 101 disposes a through hole 1011.

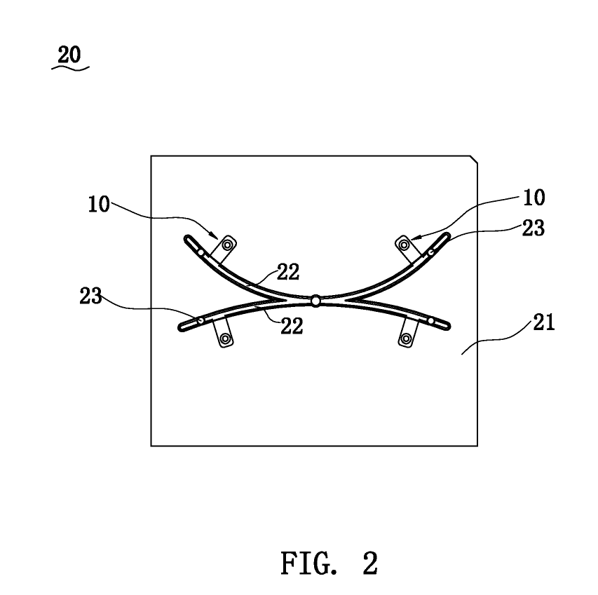

Please refer to FIG. 2 combined with FIG. 1, the mould 20 with the flowing direction regulator includes a base board 21, a first runner 22, a second runner 23 and a flowing direction regulator 10. Both the first runner 22 and the second runner 23 are disposed on the base board 21. The second runner 23 is communicated with the first runner 22 and passes through the top and bottom surfaces of the base board 21. The flowing direction regulator 10 is removable mounted on the base board 21 and extends into the first runner 22.

Referring to FIG. 2, the mould 20 with the flowing direction regulator includes two first runners 22 and four second runners 23. Understandably, the number of the first runner 22 and the second runner 23 can be determined according to concrete condition.

Specifically, the flowing direction regulator 10 includes the retaining portion 101 and the extending portion 102 extending outward from the retaining portion 101 and entering into the runner.

Specifically, the retaining portion 101 and the extending portion 102 are configured as a step-like profile, and the retaining portion 101 disposes a through hole 1011. A bolt passes through the through hole 1011 to fix the flowing direction regulator 10 to the base board 21.

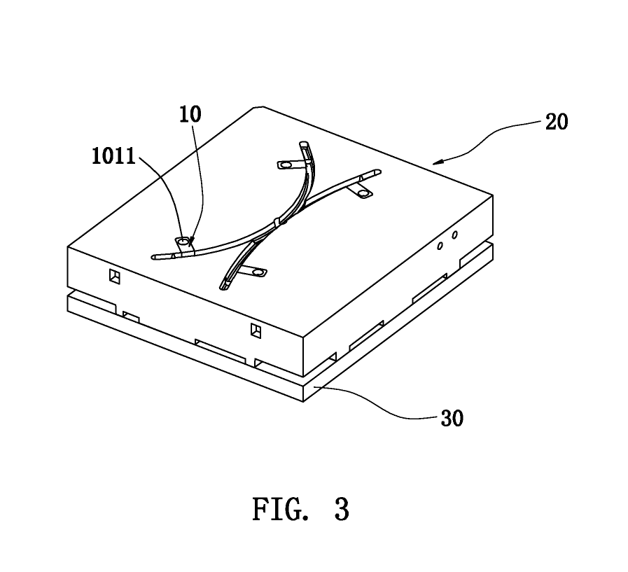

Please refer to FIG. 3 combined with FIG. 2, when a plastic product 30 is mounted on the mould 20 with the flowing direction regulator, the melt plastic-injecting location of the plastic product 30, into which the melt plastic is waiting to be injected, is corresponding to the second runner 23. The operator injects the melt plastic into the first runner 22. The melt plastic passes through the flowing direction regulator 10 to flow into the second runner 23, and then passes through the second runner 23 to arrive at the melt plastic-injecting location of the plastic product 30, thereby completing the glue-dispensing process of the plastic product 30. The extending portion 102 of the flowing direction regulator 10 extends into the first runner 22 to modify the width of the first runner 22, thereby effectively regulating the melt plastic flow of entering into the plastic product 30, resolving the problem of the different pressure needed by the different location of the plastic product 30, and effectively adjusting the gas lines of the plastic-feeding location.

As described above, the extending portion 102 of the flowing direction regulator 10 of the present invention extends into the first runner 22 to modify the width of the first runner 22, so that effectively adjusting the melt plastic flow of entering into the plastic product 30, resolving the problem of the different pressure needed by the different location of the plastic product 30, and effectively adjusting the gas lines of the plastic-feeding location. The flowing direction regulator 10 of the present invention has a simple structure and a low cost, and can be conveniently operated. Moreover, the mould 20 of the present invention employs the flowing direction regulator 10, which is removable mounted on the base board 21 and can be replaced by a new regulator to adjust the melt plastic-feeding flow according to the different plastic product. Whereby the mould 20 of the present invention can avoid to be taken apart and again fixed, so that reducing the adjusting time, and improving the working efficiency.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flowing direction regulator, which is applied to a glue-dispensing runner of a plastic product for adjusting a flowing direction of melt material in the runner, comprising:
a retaining portion; and
an extending portion, extending outward from the retaining portion, and entering into the runner.

2. The flowing direction regulator as claimed in claim 1, wherein the retaining portion and the extending portion are configured as a step-like profile, and the retaining portion disposes a through hole.

3. A mould with flowing direction regulator, comprising:
a base board;
a first runner, being disposed on the base board;
a second runner, being disposed on the base board, being communicated with the first runner, and passing through the base board; and
a flowing direction regulator, being removable mounted on the base board and extending into the first runner.

4. The mould with flowing direction regulator as claimed in claim 3, wherein the flowing direction regulator includes a retaining portion and an extending portion, which is extending outward from the retaining portion and enters into the runner.

5. The mould with flowing direction regulator as claimed in claim 4, wherein the retaining portion and the extending portion are configured as a step-like profile, the retaining portion disposes a through hole, and a bolt passes through the through hole for fixing the flowing direction regulator to the base board.
